(19) United States
(12) Patent Application Publication
(10) Pub. No.: US 2025/0224974 A1
(43) Pub. Date: Jul. 10, 2025

(54) CONFIGURATION RECOMMENDATION FOR MANAGEMENT OF VIRTUAL PROCESSING UNITS

(71) Applicant: Dell Products L.P., Round Rock, TX (US)

(72) Inventors: Parminder Singh Sethi, Ludhiana (IN); Shree Rathinasamy, Round Rock, TX (US)

(21) Appl. No.: 18/405,133

(22) Filed: Jan. 5, 2024

(51) Int. Cl. G06F 9/455

(52) U.S. Cl. CPC G06F 9/45558; G06F 2009/4557

(57) ABSTRACT

A method comprises receiving operational data corresponding to one or more virtual processing units over a designated time period. The one or more virtual processing units are in a first configuration in which the one or more virtual processing units utilize resources of one or more physical processing units. The operational data comprises resource utilization data of the one or more virtual processing units over the designated time period. The operational data is input to a time-series model, wherein the time-series model analyzes the resource utilization data to predict future resource utilization over a future time period. Based on the predicted future resource utilization, a second configuration in which the one or more virtual processing units utilize the resources of the one or more physical processing units is generated, wherein the second configuration is different from the first configuration.

### FIELD

The field relates generally to information processing systems, and more particularly to virtual processing unit management in such information processing systems.

### BACKGROUND

The proliferation of processing unit (e.g., graphics processing unit (GPU)) consumption has led to a need to provide processing units in physical and virtual forms. In the case of a virtual processing unit, a virtual machine (VM) consumes resources of one or more components of a physical server to run various workloads. However, once the assignment of virtual processing unit resources is performed, resource assignment remains static, even though computational needs may change.

### SUMMARY

Embodiments provide a platform and techniques for virtual processing unit management.

For example, in one embodiment, a method comprises receiving operational data corresponding to one or more virtual processing units over a designated time period. The one or more virtual processing units are in a first configuration in which the one or more virtual processing units utilize resources of one or more physical processing units. The operational data comprises resource utilization data of the one or more virtual processing units over the designated time period. The operational data is input to a time-series model, wherein the time-series model analyzes the utilization data to predict future resource utilization over a future time period. Based on the predicted future resource utilization, a second configuration in which the one or more virtual processing units utilize the resources of the one or more physical processing units is generated, wherein the second configuration is different from the first configuration.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1A depicts an information processing system in a first arrangement of physical GPUs and virtual GPUs (vGPUs), and comprising a platform for recommending a configuration for management of vGPUs based on computational requirements, according to an illustrative embodiment.

FIG. 1B depicts an information processing system in a second arrangement of physical GPUs and vGPUs, and comprising a platform for recommending a configuration for management of vGPUs based on computational requirements, according to an illustrative embodiment.

FIG. 2A depicts an architecture of the platform for recommending a configuration for management of vGPUs in connection with the first arrangement of physical GPUs and vGPUs, according to an illustrative embodiment.

FIG. 2B depicts an architecture of the platform for recommending a configuration for management of vGPUs in connection with the second arrangement of physical GPUs and vGPUs, according to an illustrative embodiment.

FIG. 3 depicts an information processing system in a combination of the first and second arrangements of physical GPUs and vGPUs, and comprising the platform for recommending the configuration for management of vGPUs, according to an illustrative embodiment.

FIG. 4 depicts a process for recommending a configuration for management of vGPUs, according to an illustrative embodiment.

FIGS. 5 and 6 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

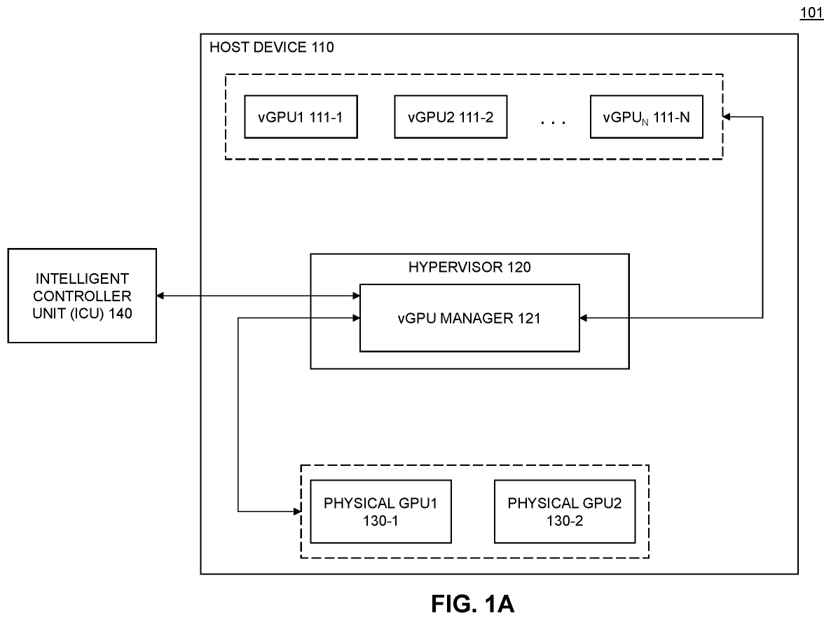

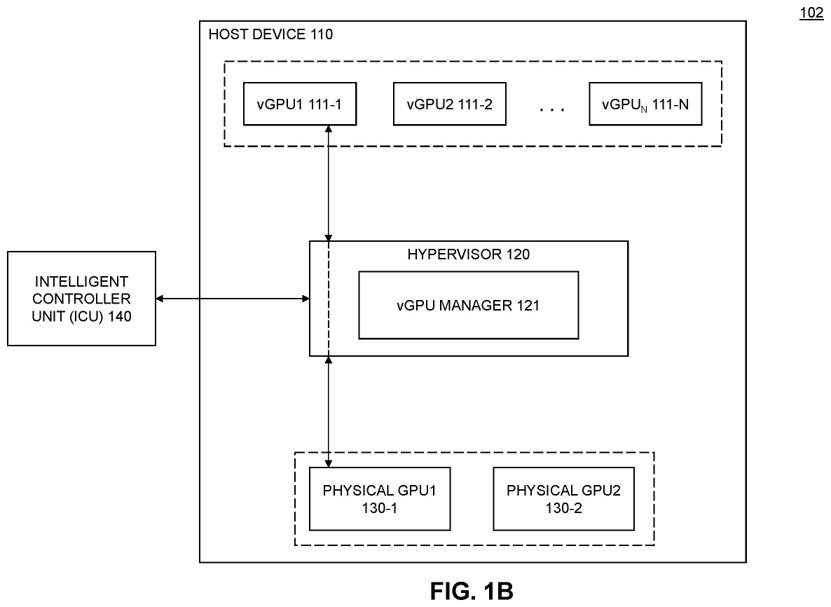

FIG. 1A depicts an information processing system 101 in a first arrangement of physical GPU1 130-1 and physical GPU2 130-2 (collectively physical GPUs 130) and vGPU1 111-1, vGPU2 111-2, . . . , vGPU_{N} 111-N (collectively “vGPUs 111”), and FIG. 1B depicts an information processing system 102 in a second arrangement of physical GPUs 130 and vGPUs 111. Each of the information processing systems 101 and 102 comprises a platform for recommending a configuration for management of vGPUs based on computational requirements. In illustrative embodiments, the platform comprises an intelligent controller unit (ICU) 140, and each of the vGPUs 111 correspond to a VM. Although the embodiments are discussed in terms of physical GPUs and vGPUs, the embodiments are not necessarily limited thereto, and may be applicable to other types of physical and virtual processing units such as, for example, central processing units (CPUs), neural processing units (NPUs), vision processing units (VPUs), physics processing units (PPUs), tensor processing units (TPUs), video processing units (VPUs), coprocessors, etc. Additionally, although two physical GPUs 130 are shown, the embodiments are not necessarily limited thereto, and may include more or less than two physical GPUs 130 or other types of physical processing units.

The information processing systems 101 and 102 comprise a host device 110 including the vGPUs 111, the physical GPUs 130 and a hypervisor 120 comprising a vGPU manager 121 (also referred to herein as a “vGPU management component”). The host device 110 communicates over one or more networks with the ICU 140. The networks comprise at least a portion of a global computer network such as the Internet, although other types of networks can be part of the networks, including a wide area network (WAN), a local area network (LAN), a satellite network, a telephone or cable network, a cellular network, a wireless network such as a WiFi or WiMAX network, or various portions or combinations of these and other types of networks. The networks comprise combinations of multiple different types of networks each comprising processing devices configured to communicate using Internet Protocol (IP) or other related communication protocols.

In a non-limiting illustrative example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The host device 110 illustratively comprises a computer, server or other types of processing device capable of communicating with the ICU 140. As noted herein, at least a portion of the host device 110 is implemented with VMs, containers, etc. The host device 110 and/or ICU 140 can comprise, for example, a desktop, laptop or tablet computer, server, storage device or other type of processing device. Such a device is an example of what is more generally referred to herein as a “processing device.” Some of the processing devices are also generally referred to herein as “computers.” The host device 110 and/or ICU 140 in some embodiments comprises a computer associated with a particular company, organization or other enterprise. It is to be understood that although the embodiments are discussed in terms of a host device 110 and/or ICU 140 (e.g., user, customer or client device), the embodiments are not necessarily limited thereto, and may be applied to different devices (e.g., edge or cloud devices).

The terms “user,” “customer,” “client” or “administrator” herein are intended to be broadly construed so as to encompass numerous arrangements of human, hardware, software or firmware entities, as well as combinations of such entities. At least a portion of the available services and functionalities provided by the host device 110 and/or ICU 140 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments. Although not explicitly shown in FIG. 1, one or more input-output devices such as keyboards, displays or other types of input-output devices may be used to support one or more user interfaces to the host device 110 and/or ICU 140.

The host device 110 comprises advanced virtualization capabilities across VMs and logical partitions (LPARs), which creates multiple vGPUs 111 out of one or more physical GPUs 130. The hypervisor 120 controls the vGPUs 111 running in, for example, one or more LPAR of the host device 110. More than one similarly situated vGPU 111 under control of the hypervisor 120 may be running in different LPARs of the host device 110.

The host device 110 illustratively provides compute services such as execution of one or more applications on behalf of each of one or more users associated with the host device 110. The term “user” herein is intended to be broadly construed so as to encompass numerous arrangements of human, hardware, software or firmware entities, as well as combinations of such entities.

In the information processing system 101, in a shared configuration, the physical GPUs 130 are shared across vGPUs 111 (e.g., VMs) controlled by hypervisor 120. The vGPU manager 121 on the hypervisor 120 manages the interaction between the vGPUs 111 and the physical GPUs 130. For example, as shown in FIG. 1A, physical GPU1 130-1 and physical GPU2 130-2 resources are shared across vGPU1 111-1, vGPU2 111-2, . . . , vGPU_{N} 111-N. As explained in more detail herein, in illustrative embodiments, the vGPU manager 121 creates and maintains physical GPU to vGPU mapping information and assigns vGPUs 111 to VMs and LPARs.

In the information processing system 102, in a pass-through configuration, a physical GPU (e.g., physical GPU1 130-1) is directly allocated to a single vGPU (e.g., vGPU1 111-1) in, for example, a 1:1 relationship. In this case, the entire allocated physical GPU 130-1 is consumed by the single vGPU1 111-1 (e.g., a single VM) to run workloads of the single vGPU1 111-1. In the pass-through configuration, a connection between the single physical GPU 130-1 and the single vGPU 111-1 passes through the hypervisor 120 controlling the one or more VGPUs 111, without management of the vGPUs 111 by the vGPU manager 121.

If a shared or a pass-through configuration is an initial configuration based on, for example, application type and user density when first setting up the information processing systems 101 and 102, the embodiments advantageously provide a platform (e.g., ICU 140) to dynamically evaluate changing conditions associated with the information processing systems 101 and 102 and to recommend and implement a configuration for management of vGPUs based on changing (e.g., real-time) computational requirements. In more detail, there are various factors affecting vGPU to physical GPU assignments and management structure. For example, for virtual desktop infrastructure (VDI) solutions, robust responsiveness may be a critical factor along with user density. For graphics intense applications, frames per second may be a critical factor, and for machine learning applications, focus may be on providing a compute-intensive resource allocation. Once an initial configuration of physical and virtual processing units and their management is implemented, the illustrative embodiments advantageously avoid a static (e.g., unchanging) application of the configuration. Instead, illustrative embodiments provide for periodic and/or continuous analysis of operational data associated with physical processing unit resource usage by virtual processing units so that new configurations of physical and virtual processing units and their management can be recommended and implemented based on changing computational demand of a system.

For example, over time, there may be changes to the number and type of applications and/or workloads being executed on the virtual processing units. To avoid under- and/or over-utilization of processing unit resources and poor performance, the illustrative embodiments provide an automated framework for dynamically interpreting computational needs of VMs in connection with the operation of vGPUs. Advantageously, the illustrative embodiments provide techniques for utilizing ICU (e.g., ICU 140) to collect operational data of virtual processing units (e.g., vGPUs 111) and analyze the consumption of computational resources on each virtual processing unit. The operational data includes, for example, data points corresponding to the computational needs of each virtual processing unit present in a pool of virtual processing units over a given time period.

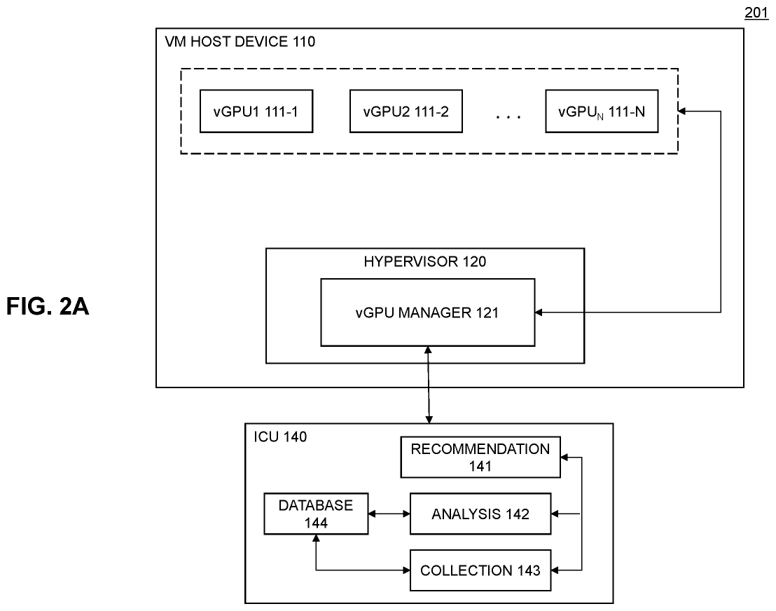

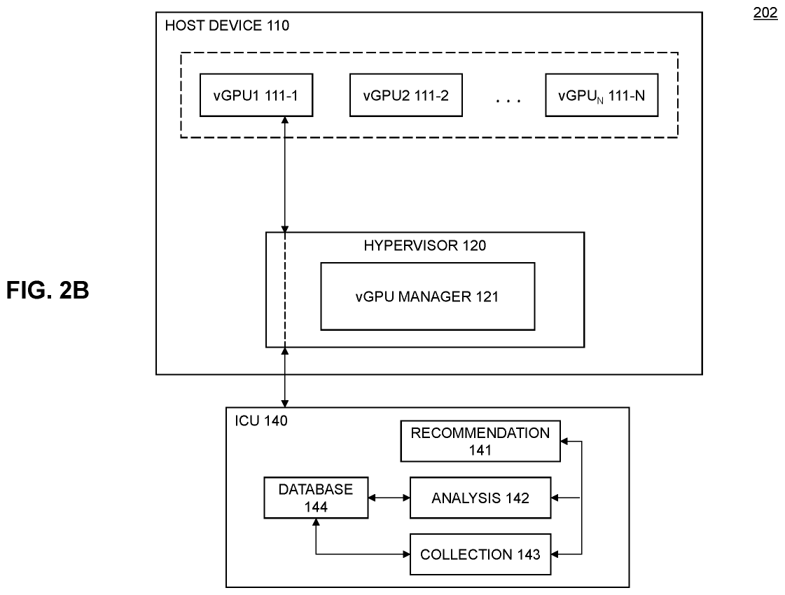

FIG. 2A depicts an architecture 201 of the ICU 140 in connection with the shared configuration of physical GPUs 130 and vGPUs 111 and management using a vGPU manager 121, and FIG. 2B depicts an architecture 202 of the ICU in connection with the pass-through configuration of physical GPUs 130 and vGPUs 111.

In each of the architectures 201 and 202, the ICU 140 comprises a recommendation engine 141, an analysis engine 142, a collection engine 143 and a database 144. In the architecture 201 in FIG. 2A, operational data is collected from one or more vGPUs 111 over a designated time period and sent to the vGPU manager 121 on the hypervisor 120. This data is then sent to the collection engine 143 of the ICU 140. Additionally or alternatively, the operational data can be pulled from the vGPU manager 121 by the collection engine 143 of the ICU 140.

In illustrative embodiments, the collection engine 143 communicates with the vGPU manager 121 to pull and/or receive the operational data of each vGPU 111 and store it in the database 144.

In the architecture 202 in FIG. 2B, which corresponds to the pass-through configuration where respective vGPUs 111 are in a direct correspondence with respective physical GPUs 130, there is no need for the vGPU manager 121 to be available on the hypervisor 120. Due to this, operational data from one or more vGPUs 111 in the pass-through configuration is first forwarded to the hypervisor 120, which then passes the data on to the collection engine 143 of the ICU 140. Additionally or alternatively, the collection engine of the ICU 140 can pull the operational data from the hypervisor 120.

In either architecture 201 or 202, the database 144 stores the operational data for further analysis by the analysis engine 142. As explained herein above, the vGPUs 111 are in an initial configuration in which the vGPUs 111 utilize resources of one or more physical GPUs 130. The operational data comprises resource utilization data of the one or more virtual processing units over the designated time period. The resource utilization data comprises, for example, processing unit (e.g., GPU) utilization (e.g., number of processing unit cores (millicores)) and memory utilization of the one or more physical GPUs 130 corresponding to respective ones of the vGPUs 111 in the initial configuration. Memory utilization amounts can include, for example, amounts of ephemeral storage of a given physical GPU 130 and/or amounts of random access memory (RAM) associated with a given physical GPU 130. In illustrative embodiments, the resource utilization data comprises average processing unit and memory utilization values. The operational data further comprises, for example, hosting instance identifiers (e.g., container, pod and/or VM IDs) and a number of hosting instances (e.g., containers, pods, VMs). The operational data can be in the form of one or more logs, such as, for example, a lifecycle (LC) log and/or a system event log (SEL).

The operational data is input to the analysis engine 142, which utilizes a time-series model to analyze the resource utilization data to predict future resource utilization over a future time period. In illustrative embodiments, the time-series model comprises an autoregressive integrated moving average (ARIMA) time series machine learning model to maintain real-time results. The ARIMA time series machine learning model is used to forecast the future resource utilization over a future time period at regular time intervals and to describe the autocorrelations in the data to analyze the performance of the vGPUs 111 (and corresponding physical GPUs 130) at regular periods. For example, analysis engine 142 executes the ARIMA time series machine learning model to determine real-time performance states of respective ones of the vGPUs 111 (and corresponding physical GPUs 130).

In more detail, data from the database 144 that was collected and/or received by the collection engine 143 including, for example, resource utilization data (e.g., real-time resource utilization data) of the vGPUs 111 (and corresponding physical GPUs 130), is applied to one or more time series machine learning models, such as, for example, the ARIMA model, to predict future resource utilization of the vGPUs 111 (and corresponding physical GPUs 130). In some embodiments, the collection engine 143 continuously monitors and collects resource utilization data via the vGPU manager 121 and/or the hypervisor 120, which is applied to a time series machine learning model, such as the ARIMA time series machine learning model.

In illustrative embodiments, the time-series model extrapolates computation consumptions. For example, using operational data points, upcoming resource requirements are plotted over a future time period to generate a prediction of upcoming resource utilization (e.g., computational requirements). For example, a time series pattern is analyzed to identify trends in computational power consumption, while neutralizing the impact of seasonal variation. In an illustrative embodiment, this is achieved by calculating three-period moving averages. For example, consumption is averaged for three periods in multiple iterations.

Based on the predicted future resource utilization, the recommendation engine 141 generates a recommended configuration in which the one or more VGPUs 111 utilize the resources of the one or more physical GPUs 130, wherein the recommended configuration is different from the initial configuration. In accordance with illustrative embodiments, the recommended configuration can comprise a shared configuration in which multiple vGPUs 111 share resources of at least one physical GPU 130 and are managed by a vGPU manager 121, a pass-through configuration in which a single vGPU 111 utilizes the resources of a single physical GPU 130 without management by a vGPU manager or a combination of shared and pass-through configurations.

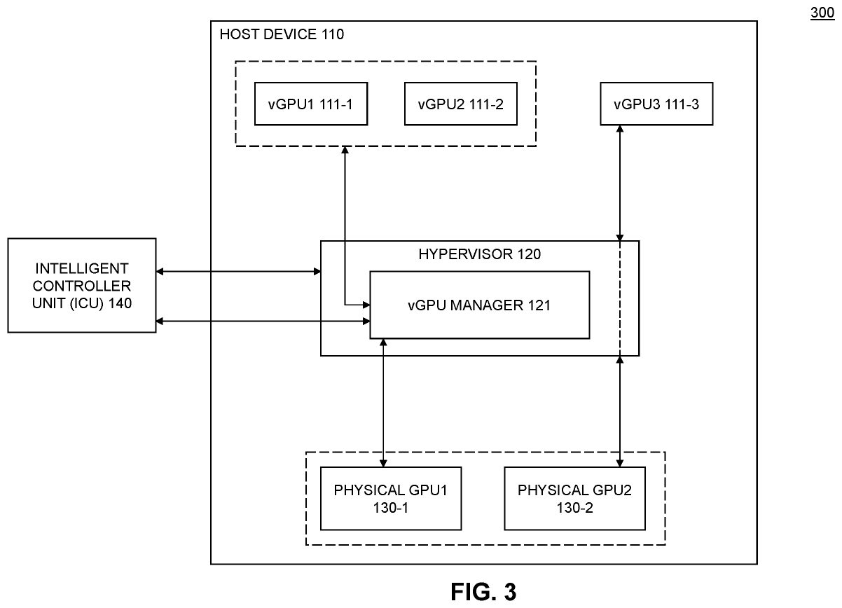

In more detail, referring to the information processing system 300 in FIG. 3, an ICU 140 and a combination of pass-through and shared configurations physical GPUs 130 and vGPUs 111 is shown. As can be seen in FIG. 3, vGPU1 111-1 and vGPU2 111-2 share the resources (e.g., processing unit and memory resources) of physical GPU1 130-1 and are managed by vGPU manager 121, while vGPU3 111-3 utilizes the resources of physical GPU2 130-2 without management by the vGPU manager 121. In the information processing system 300 in FIG. 3, the ICU communicates with the vGPU manager 121 to receive operational data associated with the operation of vGPU1 111-1 and vGPU2 111-2, and communicates with the hypervisor 120 (without utilizing the vGPU manager 121) to receive operational data associated with the operation of vGPU3 111-3.

In illustrative embodiments, the initial configuration and the recommended configuration respectively comprise a mapping of respective ones of one or more vGPUs 111 to at least one physical GPU 130. In the shared configuration, the mapping can be maintained in the vGPU manager 121 and in the pass-through configuration, the mapping can be maintained in the hypervisor 120. For a shared configuration, in an illustrative embodiment, the initial configuration and/or the recommended configuration comprises the vGPU manager 121 running on the hypervisor 120. The vGPU manager 121 is configured for managing assignment of resources from a single physical GPU 130 to at least two vGPUs 111. The vGPU manager 121 manages resource allocation from and access to physical GPUs 130.

In illustrative embodiments, the initial configuration and/or the recommended configuration comprises a pass-through configuration including an allocation of resources from a single physical GPU 130 to a single vGPU 111, wherein a connection between the single physical GPU 130 and the single vGPU 111 passes through the hypervisor 120, which controls one or more vGPUs 111.

In illustrative embodiments, the recommended configuration generated by the recommendation engine 141 comprises a combination of: (i) the vGPU manager 121 running on the hypervisor 120 and configured for managing assignment of resources from a first physical GPU of a plurality of physical GPUs 130 to a first vGPU of a plurality of vGPUs 111 and to a second vGPU of the plurality of vGPUs 111; and (ii) an allocation of resources from a second physical GPU of the plurality of physical GPUs 130 to a third vGPU of the plurality of vGPUs 111. A connection between the second physical GPU 130 and the third vGPU 111 passes through the hypervisor 120 and excludes the vGPU manager 121.

In illustrative embodiments, the recommended configuration can be based on whether the predicted future resource utilization meets and/or exceeds a designated threshold for resource utilization of at least one physical GPU 130. In a non-limiting example, if the predicted future resource utilization of a vGPU 111 is 80% or more of the resources of any single physical GPU 130, then the recommendation engine 141 may generate a recommended configuration that uses a vGPU manager 121 (e.g., shared configuration) rather than a pass-through configuration for a given pool of physical GPUs 130. In another non-limiting example, if the predicted future resource utilization of a vGPU 111 is less than 70% of the resources of any single physical GPU 130, then the recommendation engine 141 may generate a recommended configuration that uses the pass-through configuration. In another non-limiting example, if the predicted future resource utilization of one vGPU 111 is 80% or more of the resources of any single physical GPU 130, and the predicted future resource utilization of another vGPU 111 is less than 70% of the resources of any single physical GPU 130, then the recommendation engine 141 may generate a recommended configuration that uses a hybrid arrangement of the shared and pass-through configurations. An example of the hybrid arrangement is shown in the information processing system 300 in FIG. 3.

According to one or more embodiments, once the recommendation engine 141 recommends a configuration, the recommended configuration can be sent to the hypervisor 120 where the hypervisor and/or vGPU manager 121 automatically changes an initial configuration to the recommended configuration. Following automatic implementation of a recommended configuration, the ICU 140 can continue to monitor the operation of the vGPUs 111 and collect operational data regarding the resource utilization of the vGPUs 111. After a designated period of operational data collection, further analysis of the operational data is performed by the analysis engine 142. If the analysis results in a new recommended configuration by the recommendation engine 141, the new recommended configuration can be sent to the hypervisor 120 where the hypervisor and/or vGPU manager 121 automatically changes the previously recommended configuration to the new recommended configuration. Such processing can be continuously performed so that the management configurations are continuously and dynamically updated based on real-time operational data to allow for optimization of physical GPU resources. In other embodiments, the recommended configuration is transmitted over at least one network to at least one user device, where a user (e.g., administrator) can approve or reject the recommended configuration. Upon approval of the recommended configuration, the user may implement the recommended configuration and/or send the recommended configuration to the hypervisor 120 for automatic implementation. If a user rejects the recommended configuration, the rejection can be sent back to ICU 140, where any machine learning algorithms used by the analysis engine 142 and/or recommendation engine 141 can be retrained (e.g., subsequently trained) with a new dataset comprising feedback data about rejected configurations. Machine learning algorithms used by the analysis engine 142 and/or recommendation engine 141 may be initially trained with historical data including resource utilization data and corresponding configurations.

In a non-limiting operational example, an administrator can deploy an ICU 140 to multiple hypervisors on multiple host devices used for a given task (e.g., genome sequencing projects). The ICUs 140 collect operational data and use a time-series model to analyze the collected operational data and generate recommended configurations for use with multiple vGPUs 111 and multiple physical GPUs 130 of multiple host devices 110. In such a situation, the recommended configurations may be for hundreds or thousands of vGPUs 111 running sequencing workloads to optimize physical GPU resource utilization, resulting in higher vGPU performance and reduced power consumption for servers running workloads. In some embodiments, the recommendation engine 141 may generate recommendations regarding which and the amount of physical GPU resources that are assigned to vGPUs.

According to one or more embodiments, database 144, caches and other data repositories or databases referred to herein can be configured according to a relational database management system (RDBMS) (e.g., PostgreSQL). In some embodiments, database 144, caches and other data repositories or databases referred to herein are implemented using one or more storage systems or devices associated with the platform for recommending the configuration for management of vGPUs comprising the ICU 140. In some embodiments, one or more of the storage systems utilized to implement databases, caches and other data repositories referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The ICUs 140 in the embodiments of FIGS. 1A-3 are each assumed to be implemented using at least one processing device. Each such processing device generally comprises at least one processor and an associated memory, and implements one or more functional modules for controlling certain features of the ICUs 140.

At least portions of the platform for recommending the configuration for management of vGPUs comprising the ICU 140 and the elements thereof may be implemented at least in part in the form of software that is stored in memory and executed by a processor. The platform for recommending the configuration for management of vGPUs comprising the ICU 140 and the elements thereof comprise further hardware and software required for running the platform for recommending the configuration for management of vGPUs comprising the ICU 140, including, GPU hardware, virtualization infrastructure software and hardware, Docker containers, networking software and hardware, and cloud infrastructure software and hardware.

It is assumed that the platform for recommending the configuration for management of vGPUs comprising the ICU 140 and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as VMs or Linux containers (LXCs), or combinations of both as in an arrangement in which Docker containers or other types of LXCs are configured to run on VMs. The vGPUs 111 may be implemented using virtual resources such as VMs or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the platform for recommending the configuration for management of vGPUs comprising the ICU 140, and the elements thereof can each be implemented in the form of one or more LXCs running on one or more VMs. Other arrangements of one or more processing devices of a processing platform can be used to implement the platform for recommending the configuration for management of vGPUs comprising the ICU 140, as well as other elements of the platform for managing the state of a host device. Other portions of the system or architecture (e.g., systems 101, 102, 300, architectures 201, 202) can similarly be implemented using one or more processing devices of at least one processing platform.

It is to be appreciated that these and other features of illustrative embodiments are presented by way of example only, and should not be construed as limiting in any way. Accordingly, different numbers, types and arrangements of system elements such as the recommendation engine 141, analysis engine 142, collection engine 143 and other elements of the platform for recommending the configuration for management of vGPUs comprising the ICU 140, and the portions thereof can be used in other embodiments.

It should be understood that the particular sets of modules and other elements implemented in the systems 101, 102, 300 or architectures 201, 202 as illustrated in FIGS. 1A-3 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the platform for recommending the configuration for management of vGPUs comprising the ICU 140 can be offered to cloud infrastructure customers or other users as part of FaaS, CaaS and/or PaaS offerings.

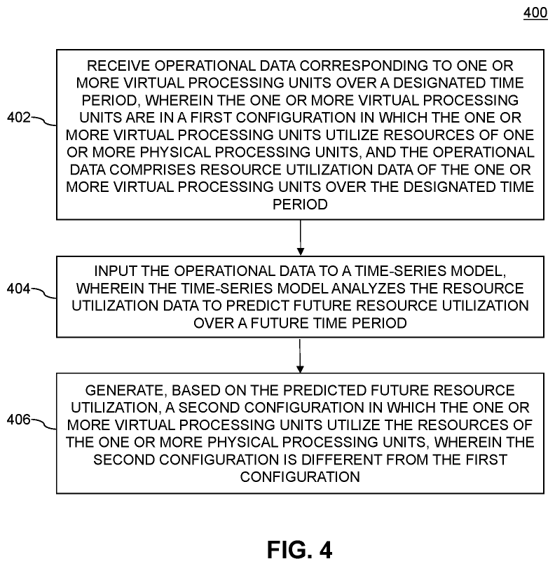

The operation of the information processing systems 101, 102, 300 or architectures 201, 202 will now be described in further detail with reference to the flow diagram of FIG. 4. With reference to FIG. 4, a process 400 for device state management based on CPU temperature as shown includes steps 402 through 406, and is suitable for use in the information processing systems 101, 102, 300 or architectures 201, 202 but is more generally applicable to other types of information processing systems or architectures comprising a platform for recommending the configuration for management of vGPUs.

In step 402, operational data corresponding to one or more virtual processing units (e.g., vGPUs) over a designated time period is received. The one or more virtual processing units are in a first (initial) configuration in which the one or more virtual processing units utilize resources of one or more physical processing units (e.g., physical GPUs 130). The operational data comprises resource utilization data of the one or more virtual processing units over the designated time period. The operational data can be received via a hypervisor controlling the one or more virtual processing units or via a virtual processing unit management component running on the hypervisor. The resource utilization data comprises at least one of processing unit utilization and memory utilization of the one or more physical processing units corresponding to respective ones of the one or more virtual processing units in the first configuration.

In step 404, the operational data is input to a time-series model, wherein the time-series model analyzes the resource utilization data to predict future resource utilization over a future time period. The time-series model may comprise at least one machine learning time-series model, and analyzing the resource utilization data may comprise computing a three-period moving average.

In step 406, based on the predicted future resource utilization, a second (e.g., recommended) configuration is generated in which the one or more virtual processing units utilize the resources of the one or more physical processing units. The second configuration is different from the first configuration. As noted herein above, the second configuration can be automatically implemented and/or transmitted over at least one network to at least one user device. The one or more virtual processing units and the one or more physical processing units can respectively comprise vGPUs and physical GPUs.

In an illustrative embodiment, the first configuration and the second configuration respectively comprise a mapping of the respective ones of one or more virtual processing units to at least one physical processing unit of the one or more physical processing units. At least one of the first configuration and the second configuration may comprise a virtual processing unit management component running on a hypervisor and configured for managing assignment of resources from a single physical processing unit of the one or more physical processing units to at least two virtual processing units of the one or more virtual processing units.

In an illustrative embodiment, at least one of the first configuration and the second configuration comprises an allocation of resources from a single physical processing unit of the one or more physical processing units to a single virtual processing unit of the one or more virtual processing units. A connection between the single physical processing unit and the single virtual processing unit may pass through a hypervisor controlling the one or more virtual processing units.

The second configuration may comprise a combination of: (i) a virtual processing unit management component running on a hypervisor and configured for managing assignment of resources from a first physical processing unit of the one or more physical processing units to a first virtual processing unit and to a second virtual processing unit of the one or more virtual processing units; and (ii) an allocation of resources from a second physical processing unit of the one or more physical processing units to a third virtual processing unit of the one or more virtual processing units, wherein a connection between the second physical processing unit and the third virtual processing unit passes through the hypervisor and excludes the virtual processing unit management component. The second configuration can be further based on whether the predicted future resource utilization one of meets and exceeds a designated threshold for resource utilization of at least one physical processing unit of the one or more physical processing units.

It is to be appreciated that the FIG. 4 process and other features and functionality described above can be adapted for use with other types of information systems configured to recommend the configuration for management of vGPUs in a configuration management platform or other type of platform.

The particular processing operations and other system functionality described in conjunction with the flow diagram of FIG. 4 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 4 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a platform for recommending the configuration for management of vGPUs as disclosed herein can provide a number of significant advantages relative to conventional arrangements. For example, the embodiments provide a technical solution including a framework to identify the computational needs of vGPUs (or other types of virtual processing units) in correlation with physical GPU (or other type of physical processing unit) consumption and to recommend optimal configurations for management of virtual processing units and consumption of resources. Advantageously, a time-series model is used to learn computation requirement patterns so that optimal policies for virtual processing units are recommended.

The embodiments advantageously provide a platform to dynamically evaluate changing conditions associated with the use of virtual processing units and to recommend and implement a configuration for management of virtual processing units based on changing (e.g., real-time) computational requirements of virtual processing units. In more detail, there are various factors affecting virtual to physical processing unit assignments and management structure. Once an initial configuration of physical and virtual processing units and their management is implemented, the illustrative embodiments advantageously avoid a static (e.g., unchanging) application of the configuration. Instead, illustrative embodiments provide for periodic and/or continuous time-series analysis of operational data associated with physical processing unit resource usage by virtual processing units so that new configurations of physical and virtual processing units and their management can be recommended and implemented based on changing computational demand of a system.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing systems 101, 102, 300 or architectures 201, 202 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the platform for recommending the configuration for management of vGPUs comprising the ICU 140 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a data packet conversion platform in illustrative embodiments. These and other cloud-based systems in illustrative embodiments can include object stores.

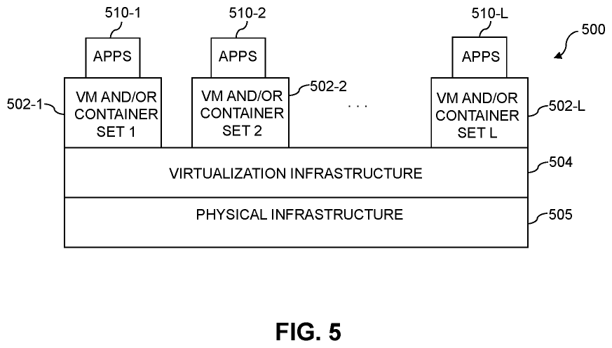

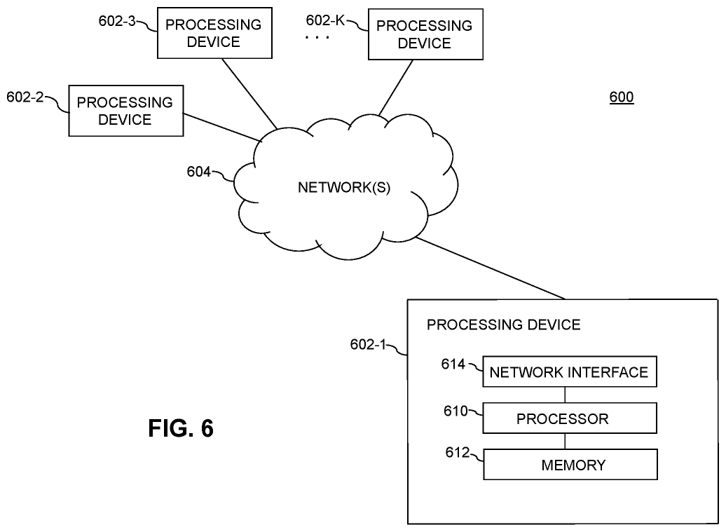

Illustrative embodiments of processing platforms will now be described in greater detail with reference to FIGS. 5 and 6. Although described in the context of information processing systems 101, 102, 300 or architectures 201, 202, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing systems 101, 102, 300 or architectures 201, 202. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing systems 101, 102, 300 or architectures 201, 202 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612. The processor 610 may comprise a microprocessor, a microcontroller, an application-specific integrated circuit (ASIC), a field-programmable gate array (FPGA), a CPU, a GPU, a TPU, a VPU or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and information processing systems 101, 102, 300 or architectures 201, 202 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the platform for recommending the configuration for management of vGPUs comprising the ICU 140 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and configuration management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving operational data corresponding to one or more virtual processing units over a designated time period;
wherein the one or more virtual processing units are in a first configuration in which the one or more virtual processing units utilize resources of one or more physical processing units; and
wherein the operational data comprises resource utilization data of the one or more virtual processing units over the designated time period;
inputting the operational data to a time-series model, wherein the time-series model analyzes the resource utilization data to predict future resource utilization over a future time period; and
generating, based on the predicted future resource utilization, a second configuration in which the one or more virtual processing units utilize the resources of the one or more physical processing units, wherein the second configuration is different from the first configuration;
wherein the steps of the method are executed by at least one processing device operatively coupled to a memory.

2. The method of claim 1 wherein the operational data is received via a hypervisor controlling the one or more virtual processing units.

3. The method of claim 2 wherein the operational data is received via a virtual processing unit management component running on the hypervisor.

4. The method of claim 1 wherein the resource utilization data comprises at least one of processing unit utilization and memory utilization of the one or more physical processing units corresponding to respective ones of the one or more virtual processing units in the first configuration.

5. The method of claim 1 wherein the one or more virtual processing units and the one or more physical processing units respectively comprise virtual graphics processing units and physical graphics processing units.

6. The method of claim 1 further comprising automatically implementing the second configuration.

7. The method of claim 1 further comprising transmitting the second configuration over at least one network to at least one user device.

8. The method of claim 1 wherein the time-series model comprises at least one machine learning time-series model.

9. The method of claim 1 wherein analyzing the resource utilization data comprises computing a three-period moving average.

10. The method of claim 1 wherein the first configuration and the second configuration respectively comprise a mapping of the respective ones of one or more virtual processing units to at least one physical processing unit of the one or more physical processing units.

11. The method of claim 1 wherein at least one of the first configuration and the second configuration comprises a virtual processing unit management component running on a hypervisor and configured for managing assignment of resources from a single physical processing unit of the one or more physical processing units to at least two virtual processing units of the one or more virtual processing units.

12. The method of claim 1 wherein at least one of the first configuration and the second configuration comprises an allocation of resources from a single physical processing unit of the one or more physical processing units to a single virtual processing unit of the one or more virtual processing units, wherein a connection between the single physical processing unit and the single virtual processing unit passes through a hypervisor controlling the one or more virtual processing units.

13. The method of claim 1 wherein the second configuration comprises a combination of: (i) a virtual processing unit management component running on a hypervisor and configured for managing assignment of resources from a first physical processing unit of the one or more physical processing units to a first virtual processing unit and to a second virtual processing unit of the one or more virtual processing units; and (ii) an allocation of resources from a second physical processing unit of the one or more physical processing units to a third virtual processing unit of the one or more virtual processing units, wherein a connection between the second physical processing unit and the third virtual processing unit passes through the hypervisor and excludes the virtual processing unit management component.

14. The method of claim 1 wherein the second configuration is further based on whether the predicted future resource utilization one of meets and exceeds a designated threshold for resource utilization of at least one physical processing unit of the one or more physical processing units.

15. An apparatus comprising:
a processing device operatively coupled to a memory and configured:
to receive operational data corresponding to one or more virtual processing units over a designated time period;
wherein the one or more virtual processing units are in a first configuration in which the one or more virtual processing units utilize resources of one or more physical processing units; and
wherein the operational data comprises resource utilization data of the one or more virtual processing units over the designated time period;
to input the operational data to a time-series model, wherein the time-series model analyzes the resource utilization data to predict future resource utilization over a future time period; and
to generate, based on the predicted future resource utilization, a second configuration in which the one or more virtual processing units utilize the resources of the one or more physical processing units, wherein the second configuration is different from the first configuration.

16. The apparatus of claim 15 wherein at least one of the first configuration and the second configuration comprises a virtual processing unit management component running on a hypervisor and configured for managing assignment of resources from a single physical processing unit of the one or more physical processing units to at least two virtual processing units of the one or more virtual processing units.

17. The apparatus of claim 15 wherein the second configuration comprises a combination of: (i) a virtual processing unit management component running on a hypervisor and configured for managing assignment of resources from a first physical processing unit of the one or more physical processing units to a first virtual processing unit and to a second virtual processing unit of the one or more virtual processing units; and (ii) an allocation of resources from a second physical processing unit of the one or more physical processing units to a third virtual processing unit of the one or more virtual processing units, wherein a connection between the second physical processing unit and the third virtual processing unit passes through the hypervisor and excludes the virtual processing unit management component.

18. An article of manufacture comprising a non-transitory processor-readable storage medium having stored therein program code of one or more software programs, wherein the program code when executed by at least one processing device causes said at least one processing device to perform the steps of:
receiving operational data corresponding to one or more virtual processing units over a designated time period;
wherein the one or more virtual processing units are in a first configuration in which the one or more virtual processing units utilize resources of one or more physical processing units; and
wherein the operational data comprises resource utilization data of the one or more virtual processing units over the designated time period;
inputting the operational data to a time-series model, wherein the time-series model analyzes the resource utilization data to predict future resource utilization over a future time period; and
generating, based on the predicted future resource utilization, a second configuration in which the one or more virtual processing units utilize the resources of the one or more physical processing units, wherein the second configuration is different from the first configuration.

19. The article of manufacture of claim 18 wherein at least one of the first configuration and the second configuration comprises a virtual processing unit management component running on a hypervisor and configured for managing assignment of resources from a single physical processing unit of the one or more physical processing units to at least two virtual processing units of the one or more virtual processing units.

20. The article of manufacture of claim 18 wherein the second configuration comprises a combination of: (i) a virtual processing unit management component running on a hypervisor and configured for managing assignment of resources from a first physical processing unit of the one or more physical processing units to a first virtual processing unit and to a second virtual processing unit of the one or more virtual processing units; and (ii) an allocation of resources from a second physical processing unit of the one or more physical processing units to a third virtual processing unit of the one or more virtual processing units, wherein a connection between the second physical processing unit and the third virtual processing unit passes through the hypervisor and excludes the virtual processing unit management component.
